(19) United States
(12) Patent Application Publication
(10) Pub. No.: US 2013/0016138 A1
(43) Pub. Date: Jan. 17, 2013

(54) DISPLAY PANEL DRIVING METHOD, DISPLAY DEVICE DRIVING CIRCUIT, AND DISPLAY DEVICE

(71) Applicant: Takashi Sasaki, Osaka-shi (JP)

(72) Inventor: Takashi Sasaki, Osaka-shi (JP)

(73) Assignee: SHARP KABUSHIKI KAISHA, Osaka-shi, Osaka (JP)

(21) Appl. No.: 13/637,416

(22) PCT Filed: Feb. 16, 2011
(86) PCT No.: PCT/JP2011/053219

§ 371 Date: Sep. 26, 2012

(30) Foreign Application Priority Data
Apr. 9, 2010 (JP) 2010-090619

(51) Int. Cl. G09G 5/10; G09G 5/00

(52) U.S. Cl. 345/690; 345/204

(57) ABSTRACT

According to a method of driving a display panel, image data is supplied to the display panel to drive the display panel. The method includes: selecting one correction data from a plurality of correction data stored in a first memory; and correcting the image data based on the selected one correction data. This driving method enables the image data to be corrected based on the one correction data selected from the plurality of correction data accordingly, as the gamma characteristic of the display panel varies due to various causes.

### TECHNICAL FIELD

The present invention relates to a method of driving a display panel, a display device driving circuit, and a display device, in particular to a technology that drives a display panel by supplying an image data to the display panel.

### BACKGROUND ART

In recent years, high-performance display devices such as a large screen television have become widely used. An image quality of the display devices is highly affected by uneven brightness and uneven color in a displayed image (hereinafter, the uneven brightness and the uneven color may be collectively referred to as “unevenness”), and thus correction of unevenness is required.

Patent Document 1 discloses a technology for correcting the unevenness. According to this technology, a display panel on which a predetermined evaluation image is displayed is captured with a camera to obtain a photographic data. Then, a brightness distribution of the display panel is obtained from the photographic data. The obtained brightness distribution of the display panel is compared with a reference brightness distribution to calculate a correction data. The correction data is used for correcting the obtained brightness distribution of the display panel to match the reference brightness distribution. According to the technology disclosed in Patent Document 1, the correction data is stored in the display device, and thus various types of unevenness caused by the design or the manufacturing process of the display panel can be reduced.

### RELATED ART DOCUMENT

### Patent Document

Patent Document 1: Japanese Unexamined Patent Publication No. 9-318929

### PROBLEM TO BE SOLVED BY THE INVENTION

However, the technology in Patent Document 1 may not properly reduce unevenness in some cases. This may happen when the unevenness is caused due to a change in temperature of the display panel. In the display device, the temperature of the display panel may be changed due to the operation thereof, and thus the gamma characteristic of the display panel is changed. This may change brightness distributions of the photographic data to be obtained, even if the same image data is supplied to the display panel. Further, this also may change a data suitable for correction. Namely, in the display device, a change in temperature of the display panel may change a correction data suitable for the display panel. The technology in Patent Document 1 stores a single correction data in a display device. However, the single correction data provided to be suitable for a predetermined temperature of the display panel may not be suitable for the current temperature of the display panel. In such a case, the single correction data cannot reduce unevenness in the display panel caused by the current temperature.

The same may be applied to the case in which unevenness is caused due to a drive frequency of the display panel. Further, the gamma characteristic may be largely changed according to usage of the display panel, such as a movie or a video game. According to the technology in Patent Document 1 in which the display device stores one correction data, even if the gamma characteristic is changed largely according to the usage of the display panel, the unevenness in the display panel cannot be reduced if correction data suitable for each gamma characteristic is required.

### DISCLOSURE OF THE PRESENT INVENTION

As described above, the gamma characteristic of the display panel may be changed for various reasons. The unevenness in the display panel may not be reduced due to such a change.

The present invention was accomplished in view of the above circumstances. It is an object of the present invention to provide a technology that can properly reduce the unevenness in the display panel.

### MEANS FOR SOLVING THE PROBLEM

To solve the above problem, a method of driving a display panel by supplying an image data thereto according to the present invention includes selecting one correction data from a plurality of correction data stored in a memory section and correcting the image data based on the selected one correction data.

In this method of driving a display panel, the image data supplied to the display panel is corrected based on the one correction data selected from the plurality of correction data. The correction data suitable for the display panel is selected, and thus the unevenness in the display panel can be properly reduced.

The method may further include performing a first measurement to measure a temperature of the display panel. In such a case, the selecting step selects the one correction data from the plurality of correction data based on the temperature measured in the first measurement. Accordingly, even if the temperature of the display panel is changed, the image data can be corrected based on the correction data suitable for the temperature of the display panel. Thus, the unevenness in the display panel can be properly reduced.

Preferably, the plurality of correction data is stored in the memory section such that each of the correction data corresponds to each of temperature ranges included in an operating temperature zone for the display panel, and the selecting step selects the one correction data corresponds to one of the temperature ranges which the temperature measured in the first measurement is included in. This enables the correction data suitable for the temperature of the display panel to be readily selected.

The method may further include performing a first calculation to calculate the plurality of correction data. In such a case, the memory section stores a plurality of gamma characteristics in each of the temperature ranges of the display panel, and the first calculation calculates the plurality of correction data each corresponding to each of the temperature ranges based on each of gamma characteristics in each of the temperature ranges. According to this driving method of a display panel, the correction data for each temperature range is calculated based on the gamma characteristic in each temperature range of the display panel. Accordingly, the image data can be corrected based on the correction data suitable for each temperature of the display panel. Thus, the unevenness in the display panel can be properly reduced.

Preferably, the memory section stores a first unevenness measurement result of the display panel, the first unevenness measurement result being obtained at a first reference temperature included in the operating temperature zone, and the first calculation calculates the plurality of correction data each corresponds to each of the temperature ranges based on the first unevenness measurement result. According to this method of driving a display panel, the plurality of correction data is calculated based on the first unevenness measurement result obtained at the first reference temperature such that each of the plurality of correction data corresponds to each of the temperature ranges. Accordingly, the image data can be corrected based on the correction data suitable for the brightness unevenness in the display panel, and thus the unevenness of the display panel can be properly reduced.

Preferably, the memory section stores a first reference correction data for a second reference temperature included in the operating temperature zone. In such a case, preferably, the memory section stores first conversion data that is used to convert the first reference correction data into the correction data corresponding to each of the temperature ranges.

The correction data for a certain temperature range may be different from the first reference correction data only in a part of the display area of the display panel when the memory section stores the first reference correction data for the second reference temperature. In such a case, the memory section is only necessary to store the correction data for the part of the display area as the conversion data. The memory section does not need to store the correction data for the entire display area of the display panel. Further, the correction data corresponding to a certain temperature range may be subjected to a change such as increase or decrease equally over the entire area of the display panel. In such a case, the memory section is only necessary to store a change rate as the conversion data. The memory does not need to store the correction data for the entire area of the display panel.

As described above, the memory section may store the first reference correction data for the second reference temperature and the conversion data. The conversion data is used to convert the first reference correction data into the correction data corresponding to each of the temperature ranges. This reduces the number of correction data required to be stored in the memory section compared with the memory section storing the plurality of correction data each corresponding to each of the temperature ranges. The second reference temperature may be set to be the same as or different from the first reference temperature.

Preferably, the first reference correction data is commonly used as the correction data corresponding to one of the temperature ranges which the second reference temperature is included in. The number of correction data required to be stored in the memory section can be further reduced by using the first reference correction data as one of the plurality of correction data corresponding to a predetermined temperature range.

Preferably, in the method of driving a display panel according to the present invention, the first measurement, the selecting step, and the correcting step are repeatedly performed at first reference time intervals in a supply period in which the image data is supplied to the display panel.

When the supply of the image data to the display panel is started, an image is displayed on the display panel and the temperature of the display panel increases. The temperature of the display panel may be changed during the supply of the image data to the display panel, and thus the correction data suitable for the display panel may be changed.

According to the present invention, the first measurement, the selecting step, and the correcting step are repeatedly performed at first reference intervals in a supply period in which the image data is supplied to the display panel. This enables the correction data to be selected accordingly as the temperature of the display panel is changed during the supply period. The image data can be corrected based on the correction data suitable for the temperature of the display panel, and thus the unevenness in the display panel can be properly reduced.

The method may further include performing a second measurement to measure a drive frequency of the display panel. In such a case, the selecting step selects the one correction data from the plurality of correction data based on the drive frequency measured in the second measurement. This enables the image data to be corrected based on the image data suitable for the drive frequency of the display panel accordingly as the drive frequency of the display panel is changed. Thus, the unevenness in the display panel can be properly reduced.

The method may further include performing a second calculation to calculate the plurality of correction data. In such a case, preferably, the memory section stores a plurality of gamma characteristics at each drive frequency of the display panel, and the second calculation calculates the plurality of correction data each corresponding to each of the drive frequencies based on each of the gamma characteristics at each of the drive frequencies. According to this method of driving a display panel, the correction data corresponding to the drive frequency is calculated based on the gamma characteristic at each of the driving frequencies of the display panel. This enables the image data to be corrected based on the image data suitable for the drive frequency of the display panel, and thus the unevenness in the display panel can be properly reduced.

Preferably, the memory section stores a second unevenness measurement result of the display panel obtained at a first reference drive frequency, and the second calculation calculates the plurality of correction data each corresponding to each of the drive frequencies based on the second unevenness measurement result. According to this method of driving a display panel, the correction data corresponding to each of the driving frequencies is calculated based on the second unevenness measurement result obtained at the first reference drive frequency. This enables the correction data to be corrected based on the correction data suitable for the brightness unevenness in the display panel, and thus the unevenness in the display panel can be properly reduced.

The memory section may store a second reference correction data corresponding to a second reference drive frequency. In such a case, preferably, the memory section stores second conversion data that is used to convert the second reference correction data into the correction data corresponding to each of the drive frequencies. This reduces the number of correction data required to be stored in the memory compared with the memory that stores the correction data for each temperature range. The second reference drive frequency maybe set to be the same as or different from the first reference drive frequency.

Preferably, in the method of driving a display panel according to the present invention, the second measurement, the selecting step, and the correcting step are repeatedly performed at second reference time intervals in a supply period in which the image data is supplied to the display panel. This enables the correction data to be selected accordingly as the frequency of the display panel is changed during the supply period. The image data can be corrected based on the correction data suitable for the frequency of the display panel, and thus the unevenness in the display panel can be properly reduced.

The method may further include performing a classification to classify the image data supplied to the display panel. In such a case, the selecting step selects the one correction data from the plurality of correction data based on data classifications obtained by the classification. Accordingly, when the gamma characteristic of the display panel needs to be changed according to the usage of the display panel, the image data can be corrected based on the correction data suitable for the usage of the display panel. Thus, the unevenness in the display panel can be properly reduced.

The method may further include performing a third calculation to calculate the plurality of correction data. In such a case, the memory section stores a plurality of gamma characteristics in the data classifications, and the third calculation calculates the plurality of correction data each corresponding to each of the data classifications based on each of the gamma characteristics in each of the data classifications. According to this method of driving a display panel, the correction data for each usage of the display panel is calculated based on the gamma characteristic in each data classification of the image data which corresponds to the usage of the display panel. This enables the image data to be corrected based on the correction data suitable for the usage of the display panel. Thus, the unevenness in the display panel can be properly reduces.

Preferably, the memory section stores a third unevenness measurement result of the display panel, and the third calculation calculates the plurality of correction data each corresponding to each of the data classifications based on the third unevenness measurement result. According to this method of driving a display panel, the plurality of correction data each corresponding to each of the data classification is calculated based on the third unevenness measurement result. This enables the image data to be corrected based on the correction data suitable for the brightness unevenness in the display panel. Thus, the unevenness in the display panel can be properly reduced.

Preferably, in the method of driving a display panel according to the present invention, the classifying step, the selecting step, and the correcting step are repeatedly performed at third reference time intervals in a supply period in which the image data is supplied to the display panel. This enables the correction data to be selected accordingly as the data classification of the image data supplied to the display panel is changed during the supply period. The image data can be corrected based on the correction data suitable for the usage of the display panel, and thus the unevenness in the display panel can be properly reduced.

Preferably, the display panel is a liquid crystal panel using liquid crystals. Accordingly, the correction data proper to the liquid crystal panel used in the large screen television can be selected. This properly reduces the unevenness.

The present invention may be embodied as a driving circuit that performs the above-described method of driving a display panel. The driving circuit for a display panel according to the present invention is configured to drive a display panel by supplying an image data thereto. The driving circuit includes a memory section configured to store a plurality of correction data, a selection section configured to select one correction data from the plurality of correction data stored in the memory section, and a correction section configured to correct the image data based on the correction data selected by the selection section. This driving circuit enables the above-described driving method to be performed, and the selection section selects the correction data suitable for the display panel. This properly reduces the unevenness.

The driving circuit may further include an input section to which a temperature measured by a thermometer is input and which is connected to the thermometer. In such a case, the selection section selects one correction data from the plurality of correction data stored in the memory section based on the temperature measured by the thermometer. The combination of the driving circuit and the thermometer can properly reduce the unevenness even if the temperature of the display panel is changed.

The driving circuit may further include a first calculation section configured to calculate the plurality of correction data, and the driving circuit may include a first circuit and a second circuit each of which is provided on a separate board. Further, the memory section may include a first memory section and a second memory section. In such a case, preferably, the first memory section is configured to store the plurality of correction data, and the second memory section is configured to store a plurality of gamma characteristics in a plurality of temperature ranges of the display panel. The first circuit includes at least the first memory section and the second circuit includes at least the second memory section. Preferably, the first calculation section calculates the plurality of correction data each corresponding to each of the temperature ranges based on each of the gamma characteristics in each of the temperature ranges stored in the second memory section. The obtained correction data is stored in the first memory section.

The driving circuit includes the first circuit and the second circuit each provided on a separate board. This enables only the first circuit to be replaced when the first circuit is damaged. Since the second circuit includes the second memory section, the first calculation section calculates the correction data corresponding to the temperature range using the gamma characteristic in each temperature range stored in the second memory section of the second circuit that is not replaced. If the first circuit and the second circuit are provided on one board, the second circuit is inevitably replaced along with the replacement of the first circuit, and thus the gamma characteristic in each temperature range of the display panel should be obtained again. However, the driving circuit of the present invention eliminates this problem. The recovery of the driving circuit can be facilitated.

The second memory section may store a first unevenness measurement result of the display panel which is obtained at a first reference temperature. In such a case, preferably, the first calculation section calculates the plurality of correction data each corresponding to each of the temperature ranges based on the first unevenness measurement result stored in the second memory section. The obtained correction data is stored in the first memory. This configuration eliminates the need to obtain the first unevenness measurement result of the display panel again even when the first circuit is replaced. Thus, the recovery of the driving circuit can be facilitated.

The driving circuit may further include an input section to which a frequency measured by a frequency measurement device is input and which is connected to the frequency measurement device. In such a case, the selection section selects one correction data from the plurality of correction data stored in the memory section based on the frequency measured by the frequency measurement device. The combination of the driving circuit and the frequency measurement device can properly reduce the unevenness in the display panel even if the drive frequency of the display panel is changed.

The driving circuit may further include a second calculation section configured to calculate the plurality of correction data, and the driving circuit may include a third circuit and a fourth circuit each of which is provided on a separate board. Further, the memory section includes a third memory section and a fourth memory section. In such a case, preferably, the third memory section is configured to store the plurality of correction data and the fourth memory section is configured to store a plurality of gamma characteristics in each of the temperature ranges of the display panel. The third circuit includes at least the third memory section and the fourth circuit includes at least the fourth memory section. The second calculation section calculates the plurality of correction data each corresponding to each of the temperature ranges based on the gamma characteristic in each of the temperature ranges stored in the fourth memory section. The obtained correction data is stored in the third memory section. This configuration eliminates the need to obtain the gamma characteristic in each of the drive frequencies of the display panel again even when the third circuit is replaced. Thus, the recovery of the driving circuit can be facilitated.

The fourth memory section may store a second unevenness measurement result of the display panel which is obtained at a first reference drive frequency. In such a case, preferably, the second calculation section calculates the plurality of correction data each corresponding to each of the temperature ranges based on the second unevenness measurement result stored in the fourth memory section. The obtained correction data is stored in the third memory. This configuration eliminates the need to obtain the second unevenness measurement result of the display panel again even when the third circuit is replaced. Thus, the recovery of the driving circuit can be facilitated.

The driving circuit may further include a classifier configured to classify the image data supplied to the display panel. In such a case, the selection section selects one correction data from the plurality of correction data in the memory section based on data classifications obtained by classification executed by the classifier. This driving circuit enables the image data to be corrected based on the correction data suitable for the usage of the display panel corresponding to each of the data classifications of the image data, when the gamma characteristic of the display panel needs to be changed according to the usage of the display panel. Thus, the unevenness in the display panel can be properly reduced.

The driving circuit may further include a third calculation section configured to calculate the plurality of correction data, and the driving circuit may include a fifth circuit and a sixth circuit each of which is provided on a separate board. Further, the memory section may include a fifth memory section and a sixth memory section. The fifth memory section is configured to store the plurality of correction data, and the sixth memory section is configured to store a plurality of gamma characteristics in each of the data classifications of the image data. In such a case, preferably, the fifth circuit includes at least the fifth memory section and the sixth circuit includes at least the sixth memory section. The third calculation section calculates the plurality of correction data each corresponding to each of the data classifications based on each of the gamma characteristics in each of the data classifications stored in the fifth memory section. The obtained correction data is stored in the fifth memory section.

The sixth memory section may store a third unevenness measurement result of the display panel. In such a case, preferably, the third calculation section calculates the plurality of correction data each corresponding to each of the data classifications based on the third unevenness measurement result stored in the sixth memory section. The obtained correction data is stored in the fifth memory section. This configuration eliminates the need to obtain the third unevenness measurement result of the display panel again even when the fifth circuit is replaced. Thus, the recovery of the driving circuit can be facilitated

The present invention may be embodied as a display device including a display panel to be driven by the above driving method. According to the present invention, the display device driven by an image data supplied thereto includes a display panel, a memory section configured to store a plurality of correction data, a selection section configured to select one correction data from the plurality of correction data stored in the memory section, and a correction section configured to correct an image data based on the correction data selected by the selection section. This display device can perform the above-described driving method. The display device can select the correction data suitable for the display panel by the use of the selection section, and thus the unevenness in the display panel can be properly reduced.

### ADVANTAGEOUS EFFECT OF THE INVENTION

According to the present invention, the unevenness in the display panel can be properly reduced.

### BRIEF DESCRIPTION OF THE DRAWINGS

FIG. 1 is a view illustrating a configuration of a liquid crystal display device 10;

FIG. 2 is a table indicating a relation between a correction data H and a temperature range PW;

FIG. 3 is a diagram indicating gamma characteristics of a liquid crystal panel 50;

FIG. 4 is a view illustrating a configuration for obtaining the gamma characteristic G and the unevenness measurement result M;

FIG. 5 is a flowchart illustrating an operation of a driving circuit 12;

FIG. 6 is a view illustrating a configuration of a liquid crystal display device 110;

FIG. 7 is a table indicating a relation between a correction data H and a drive frequency F;

FIG. 8 is a view illustrating a configuration of a liquid crystal display device 210; and

FIG. 9 is a table indicating a relation between a correction data H and a data classification X.

### MODE FOR CARRYING OUT THE INVENTION

### First Embodiment

The first embodiment of the present invention will be described with reference to the drawings. The following embodiment will be described using a liquid crystal display device equipped with a liquid crystal panel as a display device. However, the technology according to the present invention is not only applicable to such a display device, but also applicable to an active matrix type display device such as PDP (Plasma Display Panel) display device and an organic EL (electro luminescence) display device, for example.

1. Construction of a Liquid Crystal Display Device 10

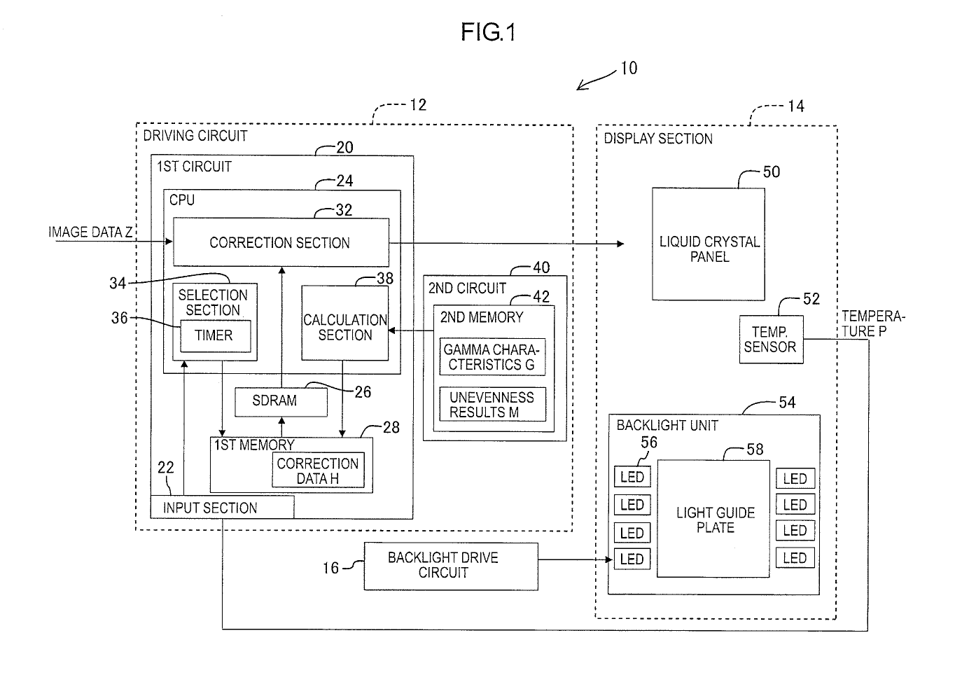

The construction of the liquid crystal display device 10 will be explained with reference to FIG. 1.

As illustrated in FIG. 1, the liquid crystal display device 10 includes a driving circuit 12, a display section 14, and a backlight driving circuit 16. The display section 14 includes a liquid crystal panel 50, a temperature sensor 52 (an example of a thermometer), and a backlight unit 54.

The liquid crystal panel 50 includes a display area on which an image is displayed using an image data. The temperature sensor 52 is arranged on a front surface of a non-display area, which is located around the display area, of the liquid crystal panel 50 to measure a temperature P of the liquid crystal pane 50. The temperature sensor 52 is connected to a first circuit 20 included in the driving circuit 12 such that the measured temperature P is sent to the first circuit 20. The backlight unit 54 is arranged behind the liquid crystal panel 50. The backlight unit 54 includes LEDs 56 (Light Emitting Diode) as light sources and a light guide plate 58 from which the light emitted from the LEDs 56 exits toward the liquid crystal panel 50.

The backlight driving circuit 16 is connected to the LEDs 56 included in the backlight unit 54. The backlight driving circuit 16 supplies current to each of the LEDs 56. The amount of current to be supplied to the LEDs 56 is controlled, and thus the amount of light to be entered into the light guide plate 58 from each of the LEDs 56 is controlled.

The driving circuit 12 supplies an image data Z that is supplied from an external device (not illustrated) to the liquid crystal panel 50 and drives the liquid crystal panel 50. The driving circuit 12 includes a first circuit 20 and a second circuit 40.

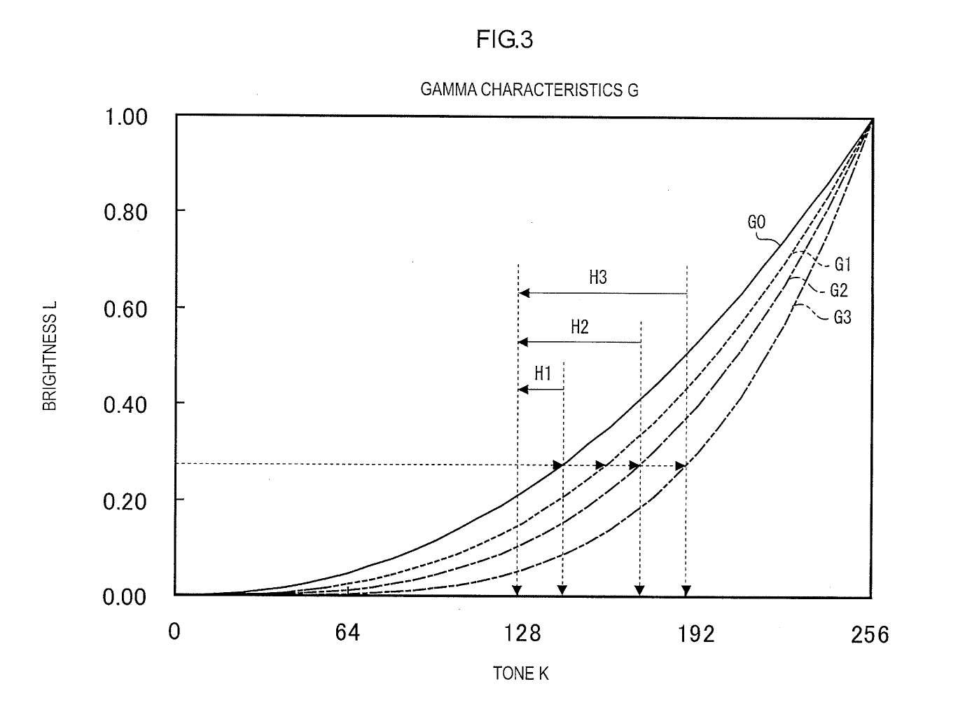

The first circuit 20 and the second circuit 40 are each provided on a separate board. The second circuit 40 is connected to the first circuit 20. The second circuit 40 includes a second memory 42 (an example of a second memory section). The second memory 42 stores a data relating to the characteristics of the liquid crystal panel 50. In other words, the second memory 42 stores gamma characteristics G1 to G3 of the liquid crystal panel 50 in respective temperature ranges PW (see FIG. 3) and unevenness measurement results M of the liquid crystal panel 50 obtained at a reference temperature PK (an example of a first reference temperature and a second reference temperature). These data are obtained in advance by using the liquid crystal panel 50 that is to be used together with the second circuit 40, and the obtained data are stored in the second memory 42.

The first circuit 20 includes the input section 22, a CPU 24, a SDRAM 26, and a first memory 28 (an example of a first memory section). The input section 22 is connected to the temperature sensor 52. The input section 22 receives the temperature P from the temperature sensor 52 and transmits it to the CPU 24.

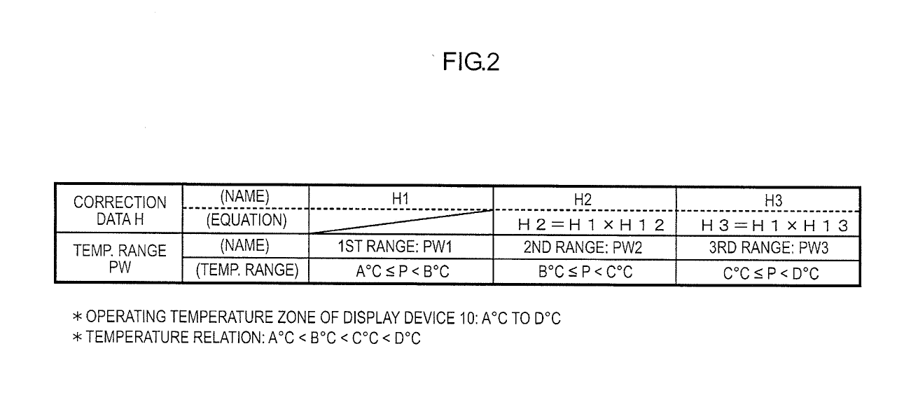

The first memory 28 stores a plurality of correction data H for the correction performed by the CPU 24. As indicated in FIG. 2, first to third temperature ranges PW1 to PW3 are determined based on an operating temperature zone (for example, 0° C. to 40° C., A° C. to D° C. in FIG. 2) of the liquid crystal device 10, and the first memory 28 stores first to third correction data H1 to H3 corresponding to PW1 to PW3.

The first temperature range PW1 includes a reference temperature PK. The first correction data H1 is the correction data H corresponding to the temperature range PW that includes the reference temperature PK. In the present embodiment, as described later, the second correction data H2 and the third correction data H3 are expressed using the first correction data H1, the conversion data H12, and the conversion data H13. The conversion data H12 and the conversion data H13 are used to convert the first correction data H1 into the second correction data H2 and the third correction data H3, respectively. The first memory 28 stores the conversion data H12 and the conversion data H13 instead of the second correction data H2 and the third correction data H3.

The CPU 24 performs various operations to correct the image data Z supplied to the liquid crystal panel 50.

The CPU 24 functions as a calculation section 38 to calculate the correction data H required for the correction of the image data Z. The correction data H is stored in the first memory 28. The CPU 24 calculates the correction data H based on the gamma characteristic G and the unevenness measurement result M that are stored in the second memory 42. The second memory 42 stores the gamma characteristics G1 to G3 of the liquid crystal panel 50 each corresponding to each of the temperature ranges PW. The CPU 24 uses the gamma characteristics G1 to G3 to calculate the correction data H1 to H3 corresponding to the temperature ranges PW. Accordingly, the correction data H suitable for the gamma characteristic G of the liquid crystal panel 50 in each of the temperature ranges PW can be calculated. Further, the second memory 42 stores the unevenness measurement result M of the liquid crystal panel 50 obtained at the reference temperature PK. The CPU 24 uses the unevenness measurement result M to calculate the correction data H corresponding to each of the temperature ranges PW. Accordingly, the correction data H that corresponds to the brightness unevenness in the liquid crystal panel 50 can be obtained.

The CPU 24 functions as a selecting section 34 to select the correction data Hand stores the selected correction data H in the SDRAM 26. The CPU 24 selects one correction data H from the plurality of correction data H stored in the first memory 28 based on the temperature P transmitted through the input section 22. Specifically, the CPU 24 selects the temperature range PW including the transmitted temperature P and selects the correction data H corresponding to the temperature range PW. The first memory 28 stores the plurality of correction data H such that each of the correction data H corresponds to each of the temperature ranges PW. This enables the CPU 24 to easily select the correction data H corresponding to the temperature P of the liquid crystal panel 50.

The CPU 24 includes a timer 36. The timer 36 measures time elapsed from the start of the supply of the image data Z to the liquid crystal panel 50. The CPU 24 repeatedly selects the correction data H from the start of the supply of the image data Z at reference time intervals TK. The CPU 24 obtains the temperature P from the input section 22 when the elapsed time J has reached the reference time interval TK, and then selects the temperature range PW that includes the temperature P. If the temperature range PW selected this time is different from the temperature range PW previously selected, the CPU 24 selects the correction data H corresponding to the temperature range PW selected this time. If the temperature range PW selected this time is the same as the temperature range PW previously selected, the correction data H previously selected is continuously used as the correction data H.

The CPU 24 functions as the correction section 32 to correct the image data Z. The correction data H is transferred between the CPU 24 and the SDRAM 26 during the correction of the image data Z. The first memory 28 is a non-volatile memory so as not to lose the correction data H even when the power of the driving circuit 12 is turned off . However, the non-volatile memory generally has a lower data transfer rate than a volatile memory such as a SDRAM. The first correction circuit 20 employs the first SDRAM 27. A processing rate of the correction is improved by transferring the correction data H between the CPU 24 and the SDRAM 26.

2. Calculation of Correction Data H (Correction Data H and the Calculation Method of the Same)

FIG. 3 illustrates the gamma characteristics G of the liquid crystal panel 50 of the present embodiment. The gamma characteristic G0 is the gamma characteristic required for the liquid crystal panel 50. The gamma characteristics G1 to G3 in each of the temperature ranges PW are measured using the liquid crystal panel 50. The gamma characteristic G0 is determined for each of the liquid crystal panel 50 such that the image data is displayed in natural colors. As indicated in FIG. 3, generally, the gamma characteristics G1 to G3 are different from the gamma characteristic G0. In order to correct the gamma characteristics G1 to G3 to match the gamma characteristic G0, the correction data H is calculated. As indicated in FIG. 3, a correction data that is required to correct a tone value K1 of the first gamma characteristic G1 at the brightness value L0 to match a tone value K0 of the gamma characteristic G0 at the brightness value L0 is a first correction data H1 at the brightness value L0. Similarly, a correction data that is required to correct a tone value K2 of the second gamma characteristic G2 at the brightness value L0 to match the tone value K0 of the gamma characteristic G0 at the brightness value L0 is a second correction data H2 at the brightness value L0, and a correction data that is required to correct a tone value K3 of the third gamma characteristic G3 at the brightness value L0 to match the tone value K0 of the gamma characteristic G0 at the brightness value L0 is a third correction data H3 at the brightness value L0.

The correction data H is set for each of the temperature ranges PW as indicated in FIG. 2 and set for each of reference brightness values LK. Further, in the liquid crystal panel 50 including a plurality of display elements (pixels), the correction data H is set for each of the display elements. FIG. 3 indicates the gamma characteristics G of the liquid crystal panel 50 that can display images with 256 tones. The brightness value L of the liquid crystal panel 50 is represented by relative brightness that is standardized by brightness values with 256 tones.

(Reason Why the Correction Data H is Needed for Each of the Temperature Ranges PW)

As indicated in FIG. 3, generally, the gamma characteristics G of the liquid crystal panel 50 change according to the temperature P of the liquid crystal panel 50. In other words, the tone values K1 to K3 at the brightness value L0 differ according to the temperature P of the liquid crystal panel 50. Thus, the use of a specific data H cannot correct all of the tone values K1 to K3 to match the tone value K0 like the conventional technology. In such a case, the brightness values L of the liquid crystal panel 50 differ from each other in each of the temperature ranges PW. Therefore, even if the same image data Z is transferred to the liquid crystal panel 50, a user cannot recognize the image data Z displayed in each of the temperature ranges PW as the same image. The driving circuit 12 of the present embodiment includes a plurality of correction data H each of which is set for each of the temperature ranges PW. Each correction data H1 to H3 is used to correct the tone values K1 to K3 to match the tone value K0. Accordingly, even if the same image data Z is input to the device and corresponding images are displayed on the display panels each having different temperature range, the user can visually recognize the images provided on the display panels as the same image.

(Reduction in Capacity of the First Memory 28)

As described above, the correction data His set for each of the temperature ranges PW and each of the reference brightness values LK, and further for each of the display elements. The first memory 28 is required to store a plurality of correction data H set for each of the display elements in different combinations of the temperature ranges PW and the reference brightness values LK. This increases the capacity of the first memory 28. The increase in the capacity of the first memory 28 may increase the cost of the first memory 28 or may deteriorate design flexibility of the first circuit 20.

In the liquid crystal panel 50, although the gamma characteristic G of each display element is different from each other, changes in the gamma characteristics G due to temperature change may be same for all of the display elements. That is, although each of the display elements has different first gamma characteristic G1, a change rate in the gamma characteristics G due to temperature change may be same for all display elements. The change rate in the gamma characteristics G due to temperature change are indicated by the conversion data H12=(K2−K0)/(K1−K0) that is related to the first gamma characteristic G1 and the second gamma characteristic G2 and the conversion data H13=(K3−K0)/(K1−K0) that is related to the first gamma characteristic G1 and the third gamma characteristic G3.

In such a case, the first memory 28 stores the first correction data H1 for each of the display elements, and further stores the conversion data H12 and the conversion data H13 as the data common to every display element. The first correction data H1 corresponds to the first temperature range PW1 that includes the reference temperature PK. This eliminates the need to store the plurality of correction data H each including a different combination of the temperature range PW and reference brightness value LK for each of the display elements. Thus, the capacity of the first memory 28 can be reduced. In selecting correction data H except for the first correction data H1 and storing it in the SDRAM 26, the CPU 24 calculates the second correction data H2 or the third correction data H3 using the first correction data H1 and the conversion data H12 or the conversion data H13, thereby storing the correction data H in the SDRAM 26.

The first correction data H1 corresponding to the first temperature range PW1 is preferably used as the reference correction data H of the conversion data H12 and the conversion data H13. Accordingly, a new reference correction data HK different from the first correction data H1 is not necessary to be set, and thus, the conversion data H11 that converts the reference correction data HK to the first correction data H1 does not need to be calculated and stored. This reduces the capacity of the first memory 28.

3. Measurement of Gamma Characteristic G and Unevenness Measurement Result M

The gamma characteristic G and the unevenness measurement result M are measured before the use of the liquid crystal display device 10. Then, the correction data H is calculated from the measurement results. Generally, the gamma characteristic G and the unevenness measurement result M should be determined for every liquid crystal display device 10 in view of factors specific to the liquid crystal panel 50 of each liquid crystal display device 10. However, if the liquid crystal panels 50 are manufactured on the same assembly line for mass production, the obtained gamma characteristic G and the cause of the unevenness may be the same. In such a case, the measurement and the calculation are performed using one liquid crystal display device 10 to obtain the gamma characteristic G and the unevenness measurement result M common to the plurality of liquid crystal display devices 10. This facilitates the measurement and the calculation performed for the liquid crystal display devices 10.

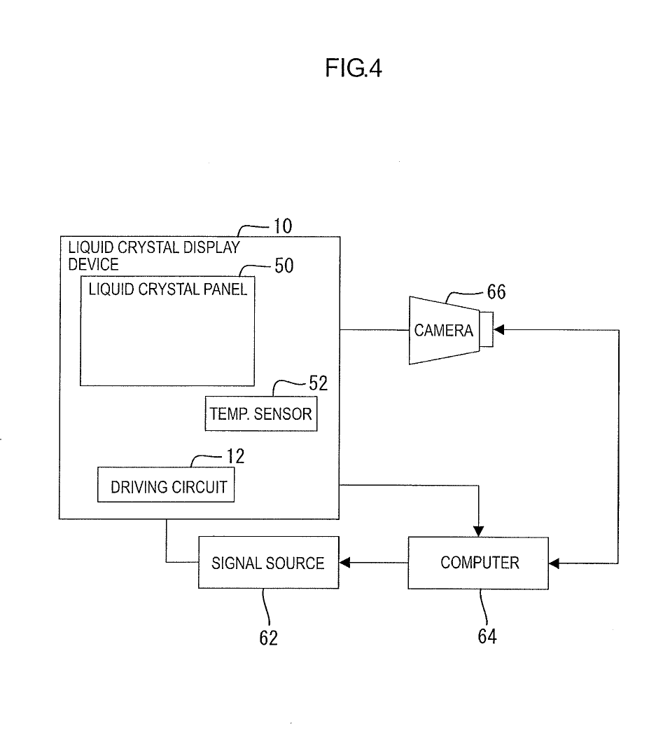

The liquid crystal display device 10 is connected as illustrated in FIG. 4 to perform the above measurement processing. The liquid crystal display device 10 is connected to a signal source 62. The signal source 62 supplies image data to display an image in the display area of the liquid crystal panel 50. A camera 66 is arranged on the front of the liquid crystal panel 50. The liquid crystal panel 50 is captured with the camera 66 to obtain a photographic data. The photographic data is transferred to a computer. The signal source 62 and the camera 66 are connected to the computer 64 to perform a specific operation by instructions from the computer 64. The computer 64 is connected to the driving circuit 12 of the liquid crystal display device 10. The computer 64 obtains the temperature P of the liquid crystal panel 50 that is measured by the temperature sensor 52, and stores the gamma characteristic M and the unevenness measurement result M in the second memory 42.

(Gamma Characteristics G)

The signal source 62 stores a plurality of image data in a solid pattern at the reference brightness value LK. The computer 64 stabilizes the temperature P of the liquid crystal panel 50 at a target measurement temperature to determine the gamma characteristic G of the liquid crystal panel 50. Then, the computer 64 supplies an image data in a solid pattern to the liquid crystal panel 50 from the signal source 62. The computer 64 controls the camera 66 to capture the liquid crystal panel 50 to which the image data has been supplied, and then obtains a photographic data. The computer 64 extracts the brightness value L from the obtained photographic data. The computer 64 controls the camera 66 to repeatedly capture the liquid crystal panel 50 with varying reference brightness values LK and varying temperatures P of the liquid crystal panel 50, and thus the gamma characteristics G are measured.

(Unevenness Measurement Result M)

The signal source 62 stores an image data in a solid pattern having a white gradation level. The computer 64 stabilizes the temperature P of the liquid crystal panel 50 at a reference temperature PK to measure the brightness unevenness in the liquid crystal panel 50. Then, the computer 64 supplies an image data in a solid pattern from the signal source 62 to the liquid crystal panel 50. The computer 64 controls the camera 66 to capture the liquid crystal panel 50 to which the image data has been supplied, and then obtains a photographic data. The computer 64 extracts the brightness value L from the obtained photographic data, and thus the unevenness measurement result M is obtained.

The computer 64 transmits the obtained gamma characteristics M and the unevenness measurement results M to the driving circuit 12 so as to be stored in the second memory 42. The CPU 24 can calculate the correction data H based on the obtained gamma characteristics G and the unevenness measurement results M.

4. Operation of the Driving Circuit 12

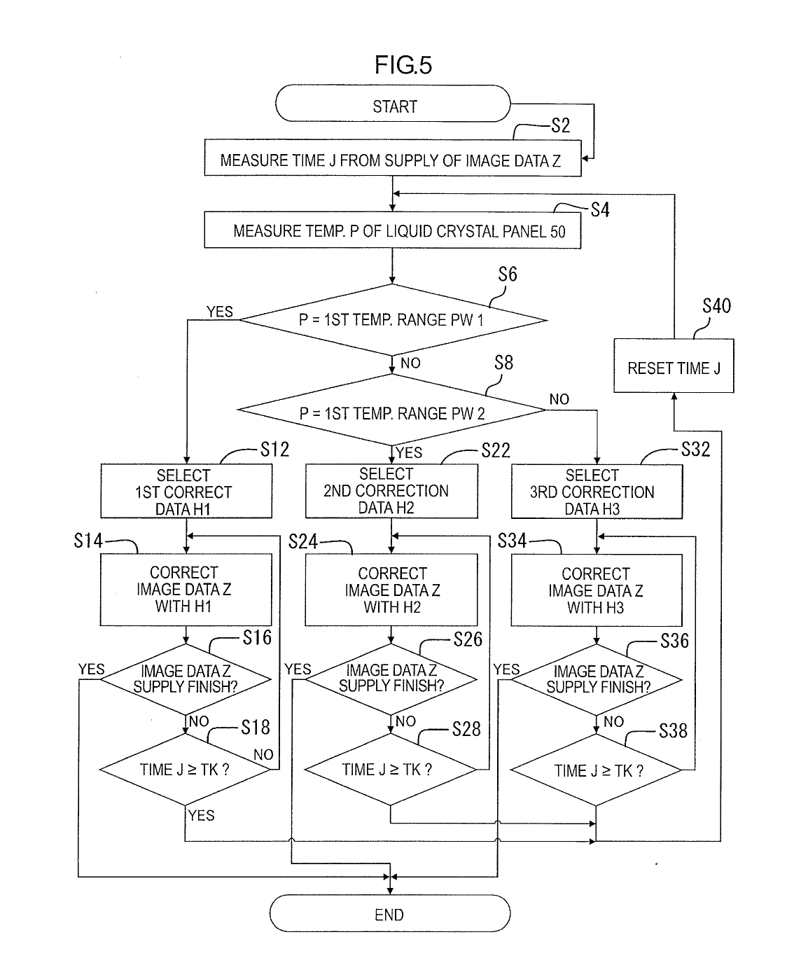

The operation of the driving circuit 12 will be explained with reference to FIG. 5. When the external device starts supplying the image data Z during the use of the liquid crystal display device 10, the CPU 24 measures the elapsed time J from the start of the supply of the image data Z (step S2). Then, the CPU 24 measures the temperature P of the liquid crystal panel 50 with the temperature sensor 52 (step S4), and determines which one of the temperature ranges PW the temperature P is included in (step S6, S8). The temperature ranges PW are indicated in FIG. 2.

If the CPU 24 determines that the temperature P is within the first temperature range PW1 (YES in step S6), the first correction data H1 is selected (step S12), and then the image data Z is corrected based on the first correction data H1 (step S14). If the CPU 24 determines that that the temperature P is within the second temperature range PW2 (NO in step S6 and YES in step S8), the second correction data H2 is selected (step S22), and then the image data Z is corrected based on the second correction data H1 (step S24). If the CPU 24 determines that the temperature P is within the third temperature range PW3 (NO in step S6 and NO in step S8), the third correction data H3 is selected (step S32), and then the image data Z is corrected based on the third correction data H3 (step S34).

If the supply of the image data Z is not completed (NO in step S16, S26, S36) and the elapsed time J does not reach the reference time interval TK (NO in step S18, S28, S38), the CPU 24 repeats the correction in steps S14, S24 and S34. If the supply of the image data Z is not completed (NO in step S16, S26, S36) and the elapsed time J is equal to or longer than the reference time interval TK (YES in step S18, S28, S38), the CPU 24 resets the elapsed time J (step S4) and returns to step S4 to measure the temperature P of the liquid crystal panel 50. If the supply of the image data Z is completed (YES in step S16, S26, S36), the CPU 24 terminates its operation.

5. Characteristics of the Driving Circuit 12

(1) In the driving circuit 12 of the present invention, the first memory 28 stores the correction data H1 to H3 corresponding to the temperature ranges PW1 to PW3, respectively. The driving circuit 12 selects the correction data H based on the temperature P of the liquid crystal panel 50 that is measured by the temperature sensor 52, and corrects the image data Z. Accordingly, the image data Z can be corrected based on the correction data H suitable for the temperature P of the liquid crystal panel 50. Thus, even if the temperature P of the liquid crystal panel 50 is changed, the unevenness in the liquid crystal panel 50 can be properly reduced.

(2) The driving circuit 12 of the present invention calculates the correction data H based on the gamma characteristic G measured using the liquid crystal panel 50 in each temperature range PW and the unevenness measurement result M obtained at the reference temperature PK. The image data Z is corrected based on this correction data H. Accordingly, the image data Z can be corrected based on the correction data H obtained with reference to the variation of the gamma characteristics G caused by the change in the temperature P of the liquid crystal panel 50 and the brightness unevenness specific to the liquid crystal panel 50. This properly reduces unevenness in the liquid crystal panel 50.

(3) In the driving circuit 12 of the present invention, after the start of the supply of the image data Z to the liquid crystal panel 50, the temperature P of the liquid crystal panel 50 is measured at reference time intervals TK. If the temperature P of the liquid crystal panel 50 is changed so largely as to exceed the temperature ranges PW, the correction data H is selected again to correct the image data Z based on the selected correction data H. The correction data H can be changed accordingly as the temperature P of the liquid crystal panel 50 is changed, even if the temperature P of the liquid crystal panel 50 is changed after the start of the supply of the image data Z . This reduces the unevenness in the liquid crystal panel 50.

(4) The driving circuit 12 of the present invention includes the first circuit 20 and the second circuit 40. The first circuit 20 and the second circuit 40 are each provided on a separate board. This enables only the first circuit 20 to be replaced when the first circuit 20 is damaged. The second circuit 20 includes the second memory 42 that stores the gamma characteristics G indicating the characteristic of the liquid crystal panel 50 and the unevenness measurement results M. Accordingly, even when the first circuit 20 is replaced, the CPU 24 can calculate the correction data H with the gamma characteristics G and the unevenness measurement results M stored in the second correction circuit 40. Thus, the gamma characteristics G and the unevenness measurement results M that are required for the calculation of the correction data H do not need to be obtained again.

### Second Embodiment

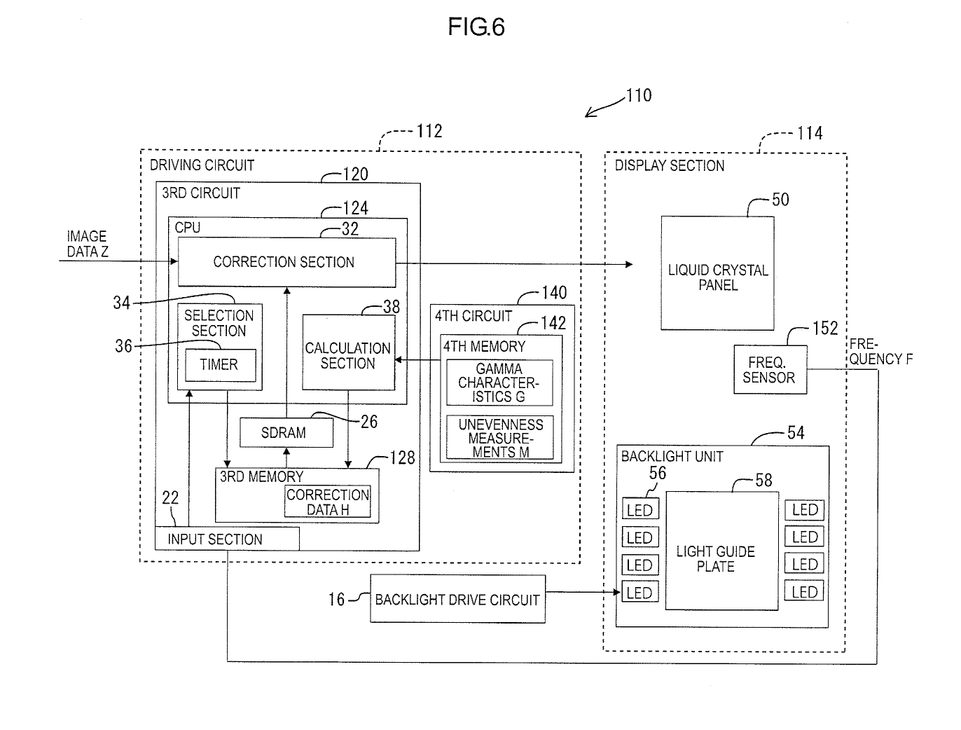

A liquid crystal display device 110 according to the second embodiment of the present invention is illustrated in FIG. 6. Unlike the liquid crystal display device 10 of the first embodiment, the liquid crystal display device 110 includes a frequency sensor 152 (an example of a frequency measurement device) in the display section 114. The frequency sensor 152 measures the frequency F of the liquid crystal panel 50. The liquid crystal display device 110 further includes a third circuit 120 including a third memory 128 and a fourth circuit 140 including a fourth memory 142 in the driving circuit 112.

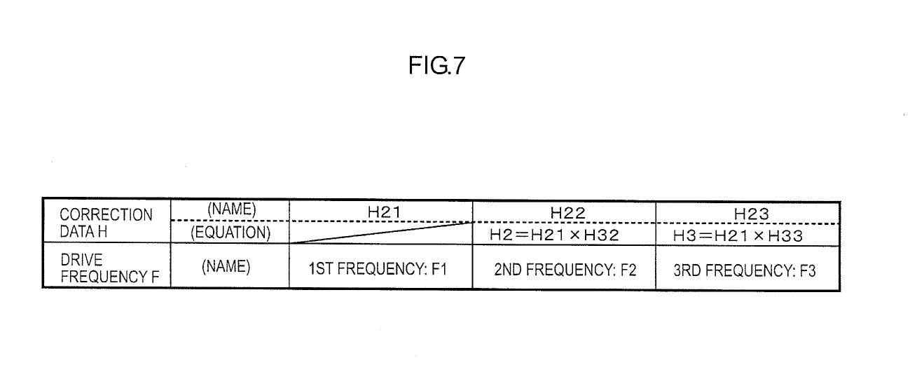

As indicated in FIG. 7, the third memory 128 stores a plurality of correction data H for the correction performed by a CPU 124. The third memory 128 stores the drive frequencies F1 to F3 of the liquid crystal display device 110 and three correction data H21 to H23 corresponding to the drive frequencies F1 to F3, respectively. The first drive frequency F1 is a reference drive frequency FP (an example of a first reference drive frequency and a second reference drive frequency) . The 21st correction data H22 is the correction data H for the reference drive frequency FP. The 22th correction data H22 is the correction data H for the second drive frequency F2 and is expressed using the 21st correction data H21 and the conversion data H32. The 23rd correction data H23 is the correction data H for the third drive frequency F3 and is expressed using the 23rd correction data H23 and the conversion data H33. The third memory 128 stores the conversion data H32 and the conversion data H33 instead of the 22nd correction data H23 and the 23rd correction data H23.

The fourth memory 142 stores the gamma characteristic G of the liquid crystal panel 50 obtained at each drive frequency F and the unevenness measurement result M of the liquid crystal panel 50 obtained at the reference drive frequency FK.

When the CPU 124 of the liquid crystal device 110 functions as the calculation section 38 to calculate the correction data H, the CPU 24 calculates the correction data H based on the gamma characteristics G and the unevenness measurement results M stored in the fourth memory 142. When the CPU 124 functions as the selection section 34 to select the correction data H, the CPU 124 selects one correction data H from the plurality of correction data H stored in the third memory 128. The correction data H is selected based on the frequency F measured by the frequency sensor 152. The CPU 124 measures the elapsed time J with the timer 36 and selects the correction data H by obtaining the frequency F when the elapsed time J exceeds the reference time interval TK.

(Characteristics of the Driving Circuit 112)

(1) In the driving circuit 112 of the present invention, the third memory 128 stores the correction data H21 to H23 corresponding to the drive frequencies F1 to F3, respectively. The driving circuit 112 selects the correction data H based on the frequency F of the liquid crystal panel 50 that is measured by the frequency sensor 152, and corrects the image data Z. Accordingly, the image data Z can be corrected based on the correction data H suitable for the frequency F of the liquid crystal panel 50. Thus, even if the frequency F of the liquid crystal panel 50 is changed, the unevenness in the liquid crystal panel 50 can be properly reduced.

(2) The driving circuit 112 of the present invention calculates the correction data H based on the gamma characteristic G measured using the liquid crystal panel 50 at each drive frequency F and the unevenness measurement result M obtained at the reference drive frequency FK. The image data Z is corrected based on this correction data H. Accordingly, the image data Z can be corrected based on the correction data H obtained with reference to the variation of the gamma characteristics G caused by the change in the frequency F of the liquid crystal panel 50 and the brightness unevenness specific to the liquid crystal panel 50. The unevenness in the liquid crystal panel 50 can be properly reduced.

(3) In the driving circuit 112 of the present invention, after the start of the supply of the image data Z to the liquid crystal panel 50, the frequency F of the liquid crystal panel 50 is measured at reference time intervals TK. If the frequency F of the liquid crystal panel 50 is changed, the correction data H is selected again to correct the image data Z based on the selected correction data H. The correction data H can be changed accordingly as the frequency F of the liquid crystal panel 50 is changed, even if the frequency F of the liquid crystal panel 50 is changed after the start of the supply of the image data Z. This reduces the unevenness in the liquid crystal panel 50.

(4) The driving circuit 112 of the present invention includes the third circuit 120 and the fourth circuit 140. The third circuit 120 and the fourth circuit 140 are each provided on a separate board. This enables only the third circuit 120 to be replaced when the third circuit 120 is damaged. The fourth circuit 140 includes the fourth memory 142 that stores the gamma characteristics G indicating the characteristic of the liquid crystal panel 50 and the unevenness measurement results M. Accordingly, even when the third circuit 120 is replaced, the CPU 124 can calculate the correction data H with the gamma characteristics G and the unevenness measurement results M stored in the fourth correction circuit 140. Thus, the gamma characteristics G and the unevenness measurement results M that are required for the calculation of the correction data H do not need to be obtained again.

### Third Embodiment

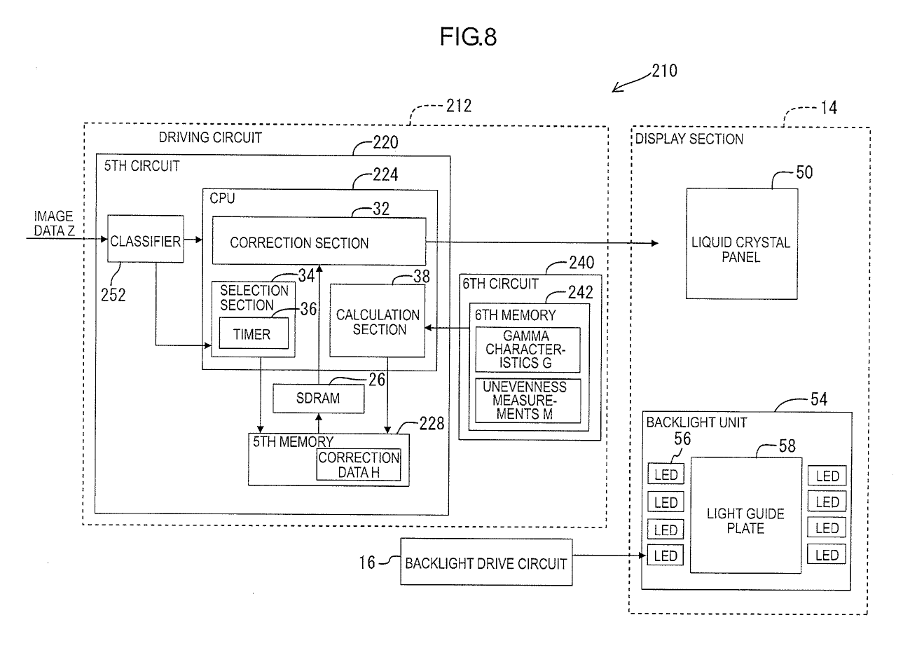

A liquid crystal display device 210 according to the third embodiment of the present invention is illustrated in FIG. 8. Unlike the liquid crystal display device 10 of the first embodiment 10, the liquid crystal display device 210 includes a fifth circuit 220 including a fifth memory 228 and a sixth circuit 240 including a sixth memory 242. The fifth circuit 220 includes a classifier 252. The classifier 252 classifies the image data Z supplied from the external device (not illustrated) and a CPU 224 receives the result thereof (data classification X). The CPU 224 uses the received data classification X to determine the usage of the liquid crystal panel 50.

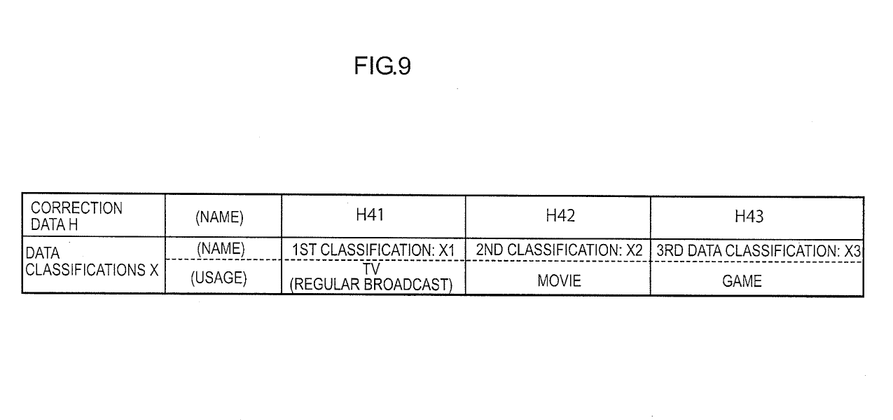

As illustrated in FIG. 9, the fifth memory 228 stores a plurality of correction data H for the correction performed by the CPU 224. The fifth memory 228 stores the data classifications X1 to X3 of the image data Z and three correction data H41 to H43 corresponding to the data classifications X1 to X3, respectively. The 41st correction data H41 is the correction data H for the first data classification X1. The 41st correction data H41 is used to correct the image data Z for TV. The 42nd correction data 42 is the correction data H for the second data classification X2. The 42nd correction data 42 is used to correct the image data Z for a movie. The 43rd correction data H43 is the correction data H for the third data classification X3. The 43rd correction data H43 is used to correct the image data Z for a video game.

The sixth memory 242 stores the gamma characteristics G for every usage (i.e., every data classification of the image data Z) of the liquid crystal panel 50. The sixth memory 242 stores the unevenness measurement results M of the liquid crystal panel 50.

When the CPU 224 of the liquid crystal display device 210 functions as the calculation section 38 to calculate the correction data H, the CPU 224 calculates the correction data H based on the gamma characteristics G and the unevenness measurement results M stored in the sixth memory 242. When the CPU 224 functions as the selection section 34 to select the correction data H, the CPU 24 selects one correction data H from the plurality of correction data H stored in the fifth memory 228. The correction data H is selected based on the data classification X sent by the classifier 252. The CPU 124 measures the elapsed time J with the timer 36 and selects the correction data H by obtaining the data classification Z from the classifier 36 when the elapsed time J exceeds the reference time interval TK.

(Characteristics of the Driving Circuit 212)

(1) In the driving circuit 212 of the present invention, the fifth memory 228 stores the correction data H41 to H43 corresponding to the data classifications X1 to X3, respectively. The driving circuit 212 selects the correction data H based on the data classification X of the image data Z that is classified by the classifier 252, and corrects the image data Z. Accordingly, the image data Z can be corrected based on the correction data H suitable for the usage of the liquid crystal panel 50. Thus, even if the gamma characteristic G of the liquid crystal panel 50 needs to be largely changed according to the usage of the liquid crystal panel 50, the unevenness in the liquid crystal panel 50 can be properly reduced.

(2) The driving circuit 112 of the present invention calculates the correction data H based on the gamma characteristic G measured using the liquid crystal panel 50 in each data classification X and the unevenness measurement result M. The image data Z is corrected based on this correction data H. Accordingly, the image data Z can be corrected based on the correction data H obtained with reference to the variation of the gamma characteristics G caused by the change in the data classification X of the image data Z suitable for the usage of the liquid crystal panel 50 and the brightness unevenness specific to the liquid crystal panel 50. The unevenness in the liquid crystal panel 50 can be properly reduced.

(3) In the driving circuit 212 of the present invention, after the start of the supply of the image data Z to the liquid crystal panel 50, the data classification X of the image data Z is measured at reference time intervals TK. If the data classification X of the image data Z is changed, the correction data H is selected again to correct the image data Z based on the selected correction data H. The correction data H can be changed accordingly as the data classification X of the image data Z is changed, even if the data classification Z of the image data Z is changed after the start of the supply of the image data Z . This reduces the unevenness in the liquid crystal panel 50.

(4) The driving circuit 212 of the present invention includes the fifth circuit 220 and the sixth circuit 240. The fifth circuit 220 and the sixth circuit 240 are each provided on a separate board. This enables only the fifth circuit 220 to be replaced when the fifth circuit 220 is damaged. The sixth circuit 240 includes the sixth memory 242 that stores the gamma characteristics G indicating the characteristic of the liquid crystal panel 50 and the unevenness measurement results M. Accordingly, even when the fifth circuit 120 is replaced, the CPU 124 can calculate the correction data H with the gamma characteristics G and the unevenness measurement results M stored in the sixth correction circuit 240. Thus, the gamma characteristics G and the unevenness measurement results M that are required for the calculation of the correction data H do not need to be obtained again.

### Other Embodiments

The present invention is not limited to the above embodiments described in the above description and the drawings. The following embodiment is also included in the technical scope of the present invention, for example.

In the above embodiments, the LED is used as a light source. A light source other than the LED may be used.

### EXPLANATION OF SYMBOLS

10: liquid crystal display device, 12: driving circuit, 14: display section, 16: backlight driving circuit, 20: first circuit, 22: input section, 24: CPU, 28: first memory, 32: correction section, 34: selection section, 38: calculation section, 40: second circuit, 42: second memory, 50: liquid crystal panel, 52: temperature sensor, 54: backlight unit, 62: signal source, 64: computer, 66: camera, 152: frequency sensor, 252: classifier, PW: temperature range, H: correction data, G: gamma characteristic, M: unevenness measurement result, Z: image data, F: frequency, X: data classification

1. A method of driving a display panel by supplying an image data thereto, the method comprising:
selecting one correction data from a plurality of correction data stored in a memory section; and
correcting the image data based on the selected one correction data.

2. The method of driving a display panel according to claim 1, further comprising performing a first measurement to measure a temperature of the display panel,
wherein the selecting step selects the one correction data from the plurality of correction data based on the temperature measured in the first measurement.

3. The method of driving a display panel according to claim 2, wherein:
the plurality of correction data is stored in the memory section such that each of the correction data corresponds to each of temperature ranges included in an operating temperature zone for the display panel; and
the selecting step selects the one correction data corresponding to one of the temperature ranges which the temperature measured in the first measurement is included in.

4. The method of driving a display panel according to claim 3, further comprising performing a first calculation to calculate the plurality of correction data, wherein:
the memory section stores a plurality of gamma characteristics in each of the temperature ranges of the display panel; and
the first calculation calculates the plurality of correction data each corresponding to each of the temperature ranges based on each of the gamma characteristics in each of the temperature ranges.

5. The method of driving a display panel according to claim 4, wherein:
the memory section stores a first unevenness measurement result of the display panel, the first unevenness measurement result being obtained at a first reference temperature included in the operating temperature zone; and
the first calculation calculates the plurality of correction data each corresponding to each of the temperature ranges based on the first unevenness measurement result.

6. The method of driving a display panel according to claim 4, wherein the memory section stores a first reference correction data for a second reference temperature included in the operating temperature zone and first conversion data that is used to convert the first reference correction data into the correction data corresponding to each of the temperature ranges.

7. The method of driving a display panel according to claim 6, wherein the first reference correction data is commonly used as the correction data corresponding to one of the temperature ranges which the second reference temperature is included in.

8. The method of driving a display panel according to claim 2, wherein the first measurement, the selecting step, and the correcting step are repeatedly performed at first reference time intervals in a supply period in which the image data is supplied to the display panel.

9. The method of driving a display panel according to claim 1, further comprising performing a second measurement to measure a drive frequency of the display panel,
wherein the selecting step selects the one correction data from the plurality of correction data based on the drive frequency measured in the second measurement.

10. The method of driving a display panel according to claim 9, further comprising performing a second calculation to calculate the plurality of correction data, wherein:
the memory section stores a plurality of gamma characteristics at each drive frequency of the display panel; and
the second calculation calculates the plurality of correction data each corresponding to each of the drive frequencies based on each of the gamma characteristics at each of the drive frequencies.

11. The method of driving a display panel according to claim 10, wherein:
the memory section stores a second unevenness measurement result of the display panel measured at a first reference drive frequency; and
the second calculation calculates the plurality of correction data each corresponding to each of the drive frequencies based on the second unevenness measurement result.

12. The method of driving a display panel according to claim 10, wherein the memory section stores a second reference correction data corresponding to a second reference drive frequency and second conversion data that is used to convert the second reference correction data into the correction data corresponding to each of the drive frequencies.

13. The method of driving a display panel according to claim 9, wherein the second measurement, the selecting step, and the correcting step are repeatedly performed at second reference time intervals in a supply period in which the image data is supplied to the display panel.

14. The method of driving a display panel according to claim 1, further comprising performing a classification to classify the image data supplied to the display panel,
wherein the selecting step selects the one correction data from the plurality of correction data based on data classifications obtained through the classification.

15. The method of driving a display panel according to claim 4, further comprising performing a third calculation to calculate the plurality of correction data, wherein;
the memory section stores a plurality of gamma characteristics in the data classifications; and
the third calculation calculates the plurality of correction data each corresponding to each of data classifications based on each of the gamma characteristics in each of the data classifications.

16. The method of driving a display panel according to claim 15, wherein the memory section stores a third unevenness measurement result of the display panel, wherein:
the third calculation calculates the plurality of correction data each corresponding to each of the data classifications based on the third unevenness measurement result.

17. The method of driving a display panel according to claim 14, wherein the obtaining step, the selecting step, and the correcting step are repeatedly performed at third reference time intervals in a supply period in which the image data is supplied to the display panel.

18. The method of driving a display panel according to claim 1, wherein the display panel is a liquid crystal panel using liquid crystals.

19. A driving circuit for driving a display panel by supplying an image data thereto, the driving circuit comprising:
a memory section configured to store a plurality of correction data;
a selection section configured to select one correction data from the plurality of correction data stored in the memory section; and
a correction section configured to correct the image data based on the correction data selected by the selection section.

20. The driving circuit for driving a display panel according to claim 19, further comprising an input section to which a temperature measured by a thermometer is input, the input section being connected to the thermometer,
wherein the selection section selects one correction data from the plurality of correction data stored in the memory section based on the temperature measured by the thermometer.

21. The driving circuit for driving a display panel according to claim 19, further comprising a first calculation section configured to calculate the plurality of correction data, wherein:
the driving circuit includes a first circuit and a second circuit, the first circuit and the second circuit each being provided on a separate board;
the memory section includes a first memory section and a second memory section, the first memory section being configured to store the plurality of correction data, the second memory section being configured to store a plurality of gamma characteristics in a plurality of temperature ranges of the display panel;
the first circuit includes at least the first memory section and the second circuit includes at least the second memory section; and
the first calculation section calculates the plurality of correction data each corresponding to each of the temperature ranges based on each of the gamma characteristics in each of the temperature ranges stored in the second memory section, the obtained correction data being stored in the first memory section.

22. The driving circuit for driving a display panel according to claim 21, wherein:
the second memory section stores a first unevenness measurement result of the display panel, the first unevenness measurement result being obtained at a first reference temperature; and
the first calculation section calculates the plurality of correction data each corresponding to each of the temperature ranges based on the first unevenness measurement result stored in the second memory section, the obtained correction data being stored in the first memory section.

23. The driving circuit for driving a display panel according to claim 19, further comprising an input section to which a frequency measured by a frequency measurement device is input, the input section being connected to the frequency measurement device,
wherein the selection section selects one correction data from the plurality of correction data stored in the memory section based on the frequency measured by the frequency measurement device.

24. The driving circuit for driving a display panel according to claim 23, further comprising a second calculation section configured to calculate the plurality of correction data, wherein:
the driving circuit includes a third circuit and a fourth circuit, the third circuit and the fourth circuit being each provided on a separate board;
the memory section includes a third memory section and a fourth memory section, the third memory section being configured to store the plurality of correction data, the fourth memory section being configured to store a plurality of gamma characteristics in a plurality of temperature ranges of the display panel;
the third circuit includes at least the third memory section and the fourth circuit includes at least the fourth memory section; and
the second calculation section calculates the plurality of correction data each corresponding to each of the temperature range based on the gamma characteristic in each of the temperature ranges stored in the fourth memory section, the obtained correction data being stored in the third memory section.

25. The driving circuit for driving a display panel according to claim 24, wherein:
the fourth memory section stores a second unevenness measurement result of the display panel, the second unevenness measurement result being obtained at a first reference drive frequency; and
the second calculation section calculates the plurality of correction data each corresponding to each of the temperature ranges based on the second unevenness measurement result stored in the fourth memory section, the obtained correction data being stored in the third memory section.

26. The driving circuit for driving a display panel according to claim 19, further comprising a classifier configured to classify the image data supplied to the display panel,
wherein the selection section selects one correction data from the plurality of correction data in the memory section based on data classifications obtained by classification executed by the classifier.

27. The driving circuit for driving a display panel according to claim 26, further comprising a third calculation section configured to calculate the plurality of correction data, wherein:
the driving circuit includes a fifth circuit and a sixth circuit, the fifth circuit and the sixth circuit being each provided on a separate board;
the memory section includes a fifth memory section and a sixth memory section, the fifth memory section being configured to store the plurality of correction data, the sixth memory section being configured to store a plurality of gamma characteristics in the data classifications of the image data;
the fifth circuit includes at least the fifth memory section and the sixth circuit includes at least the sixth memory section; and
the third calculation section calculates the plurality of correction data each corresponding to each of the data classifications based on each of the gamma characteristics in each of the data classifications stored in the fifth memory section, the obtained correction data being stored in the fifth memory section.

28. The driving circuit for driving a display panel according to claim 27, wherein:
the sixth memory section stores a third unevenness measurement result of the display panel; and
the third calculation section calculates the plurality of correction data each corresponding to each of the data classifications based on the third unevenness measurement result stored in the sixth memory section, the obtained correction data being stored in the fifth memory.

29. A display device driven by an image data supplied thereto, the display device comprising:
a display panel;
a memory section configured to store a plurality of correction data;
a selection section configured to select one correction data from the plurality of correction data stored in the memory section; and
a correction section configured to correct the image data based on the one correction data selected by the selection section.
